(19) United States
(12) Patent Application Publication
(10) Pub. No.: US 2019/0176840 A1
(43) Pub. Date: Jun. 13, 2019

(54) METHODS AND SYSTEMS FOR DETECTING FAULTS IN VEHICLE CONTROL SYSTEMS

(71) Applicant: Ningbo Geely Automobile Research & Development Co., Ltd., Ningbo (CN)

(72) Inventor: Michael PALANDER, Sävedalen (SE)

(21) Appl. No.: 16/276,779

(22) Filed: Feb. 15, 2019

Related U.S. Application Data
(63) Continuation of application No. PCT/EP2017/071453, filed on Aug. 25, 2017.

(30) Foreign Application Priority Data
Aug. 25, 2016 (EP) 16185731.3

(51) Int. Cl. B60W 50/02; G07C 5/08

(52) U.S. Cl. CPC B60W 50/0205; B60W 2050/0215; B60W 2050/021; G07C 5/0808

(57) ABSTRACT

A method for detecting faults in a vehicle control system that has functional units. Each functional unit has an associated unique label in the form of a finite field element, and the method includes: calling each of the functional units, the call comprising a readable traversal value, and in case the functional unit is operating correctly, updating the traversal value based on the unique label of the currently called functional unit; and determining from the updated traversal value if any functional units are faulty by a comparison with an expected traversal value.

### RELATED APPLICATION DATA

This application is a continuation of International Patent Application No. PCT/EP2017/071453, filed Aug. 25, 2017, and claims the benefit of European Patent Application No. 16185731.3, filed Aug. 25, 2016, the disclosures of which are incorporated herein by reference in their entireties.

### TECHNICAL FIELD

The invention relates to vehicle control systems, in particular methods and systems for detecting faults in vehicle control systems.

### BACKGROUND

Modern vehicle control systems are comprised of a network of systems, subsystems and controllers interacting to control the various components of the vehicle. For example a vehicle control system could comprise subsystems associated with a domain of features of the vehicle such as vehicle dynamics. Each of these subsystems may comprise one or more electronic control units (ECUs) which are associated with a feature of the domain, for example the vehicle dynamics subsystem may comprise an ECU relating to braking. The subsystems also comprise functional units that are related to that domain subsystem. A functional unit could for example be a brake actuation sensor. The functional units are often interconnected which makes detecting and locating faults rapidly a challenge.

With such vehicle control systems comprising numerous subsystems communicating and controlling various aspects of the vehicle, testing and validation of large electronic control systems is of significant importance. Furthermore, the increasing numbers of features in vehicle control systems has in turn increased the proportion of vehicle production costs associated with control systems. A fault detection method and system for vehicle control system being able to detect faults efficiently and effectively during production and development would thus decrease production costs and increase vehicle reliability.

### SUMMARY

Accordingly, the present invention preferably seeks to mitigate or eliminate one or more of the above-identified deficiencies in the art singly or in any combination and solves at least the above mentioned problems by providing a solution in accordance with the independent claims set forth below.

According to a first aspect, a method for detecting faults in a vehicle control system comprising functional units is provided. Each functional unit has an associated unique label in the form of a finite field element, and the method comprises calling each of the functional units, the call comprising a readable traversal value, and in case the functional unit is operating correctly, updating the traversal value based on the unique label of the currently called functional unit; and determining from the updated traversal value if any functional units are faulty by a comparison with an expected traversal value.

In an embodiment, in the case that the traversal value is not equal to the expected value, the method further comprises determining which functional units are faulty by a finite field element factorization algorithm.

The method may further comprise determining any missing unique label(s) by means of said finite field element factorization algorithm.

In an embodiment the method further comprises accessing a list, the list associating a descriptor of a functional unit to a unique label, to determine the descriptor of any faulty functional unit(s).

The traversal value may be the product of the traversal value in the call and the unique label of the currently called functional unit.

In an embodiment each unique finite field element is generated by a polynomial, preferably the polynomial is g(X)=X⁴+X³+1.

Each unique label may correspond to a unique decimal form representation, each unique decimal form representation is a prime number. The unique decimal form representations are preferably associated according to the ascending sequence of prime numbers starting at the number 2.

A unique prime number, e.g. the prime number 1, may be excluded from the set of prime numbers forming the unique decimal form representations.

In an embodiment the vehicle control system comprises two or more functional units.

The vehicle control system may further comprise subsystems being associated with vehicle hardware, wherein the subsystems comprise the functional units, the method further comprising associating the functional units with the comprising subsystem.

In an embodiment a functional unit subset is selected from the functional units comprised in the vehicle control system, and the expected traversal value of the functional unit subset is the product of the unique label of each of the functional units comprised in the functional unit subset.

According to a second aspect, a method for providing at least one functional unit is provided. The method comprises assigning a unique label in the form of a finite field element to a functional unit.

According to a third aspect a controller for detecting faults in a vehicle control system comprising functional units is provided. Each of the functional units of the vehicle control system are assigned a unique label in the form of a finite field element. The controller for detecting faults comprises a means of calling the functional units wherein the call to the functional unit comprises a readable traversal value, a means of, in case the functional unit is operating correctly, updating the traversal value based on the unique label of the currently called functional unit, and a processing unit programmed to determine which if any of the functional units are faulty by a comparison between the updated traversal value and an expected traversal value.

In an embodiment, if the updated traversal value is not equal to the expected traversal value, the processing unit is further programmed to determine which functional units are faulty by a finite field element factorization algorithm.

According to a fourth aspect, a system comprising a hardware component of a vehicle being associated with one of more functional units and a controller according to the third aspect is provided.

### BRIEF DESCRIPTION OF DRAWINGS

Further objects, features and advantages will appear from the following detailed description, with reference being made to the accompanying drawings, in which:

FIG. 1 is a schematic view of a method according to an embodiment;

FIG. 2 is a schematic view of a method according to another embodiment; and

FIG. 3 is a blocksheet diagram of the method according to an embodiment.

### DETAILED DESCRIPTION

The following description of the invention concerns methods, controllers and systems for detecting faults in vehicle control systems comprising functional units having an associated unique label. The functional units may be associated with specific components of a vehicle. For instance, the functional units may be associated with those directly related to the movement of the vehicle, such as a break actuation sensor. The functional units may also be associated with components related to ancillary aspects of the vehicle such as a seat warming controller. Through the described methods, controllers and systems faults in one or more individual functional units can be detected and located efficiently and effectively. The vehicle control system can comprise one or more functional units, such as two or more. Functional units may in some embodiments be software implemented.

According to the various embodiments described herein, functional units are assigned a unique label to enable identification. Such method 20 is generally depicted in FIG. 2. The unique label can be assigned 24 to the functional unit during or prior to run-time, and preferably after accessing the functional unit 22. The unique label acts as an identifier of the functional unit throughout the fault detection method. The method of assigning the unique labels is to assign labels in the form of finite field elements, wherein each finite field element corresponds to a unique decimal form representation. Preferably, the unique decimal form representations are selected and associated according to the ascending sequence of prime numbers starting at the number 2. That is, the unique label of the first functional unit is assigned a finite field element representing the number 2, the unique label of the second functional unit is assigned a finite field element representing the number 3, the unique label of the third functional unit is assigned a finite field element representing the prime number 5, and so on. A finite field element representing the prime number 1 is preferably not used as will be further explained below.

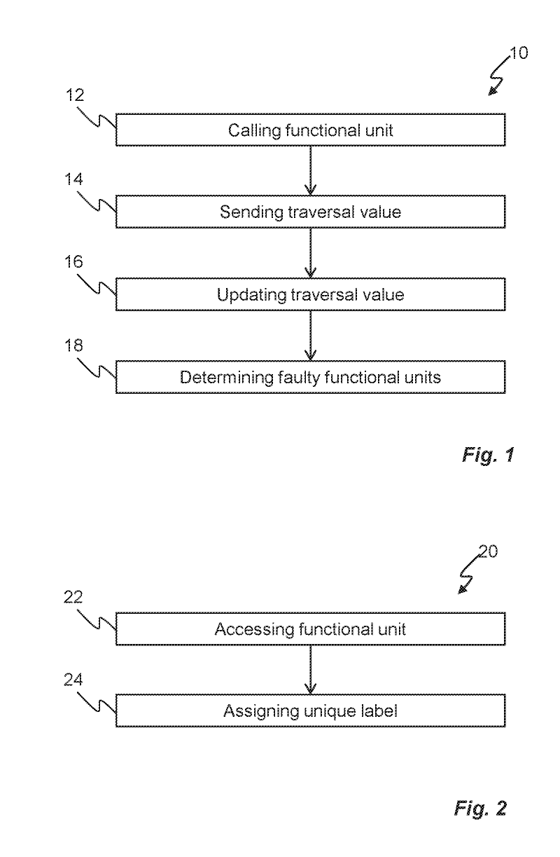

Each functional unit can be called during the fault detection method. The fault detection method 10 is schematically shown in FIG. 1. The call 12 to the functional unit comprises a traversal value. The traversal value is a value which can be both read and updated by the respective receiving functional unit. The traversal value which is provided 14 to the first functional unit during fault detection is a finite field element corresponding to the unique decimal form representation of the prime number “1”.

On receiving the call, in the case that the receiving functional unit is operating correctly, the receiving functional unit can update 16 the traversal value to be equal to the product of the traversal value comprised in the call and the unique label of the currently called functional unit. The multiplication results in a product which is the product of the receiving functional unit's unique label and the product of all unique labels of the functional units previously called that were without error. The traversal value is then updated to be equal to the product.

A faulty functional unit which is an error state will not update the traversal value. The traversal value will thus be unchanged by a functional unit which is faulty. The traversal value is then passed in a call to the next functional unit. The next functional unit repeats the multiplication process described above with its own unique label.

To determine if any of the functional units are faulty the traversal value can be compared to an expected traversal value. To determine 18 which functional units are in error a unique finite field element factorisation algorithm is used.

After being passed to one or more functional units the traversal value is compared to an expected traversal value. The expected traversal value may be the product of all of the unique labels of functional units in the system in which faults are to be detected.

If the traversal value is equal to the expected traversal value then no faults have been detected in the system.

If the traversal value is not equal to the expected traversal value then one or more faulty functional units have been detected.

To determine which functional unit is faulty a unique finite field element factorisation algorithm is used.

Before describing the finite field factorisation algorithm some general description of finite fields will be given.

A finite field, also commonly known as a Galois field, is a mathematical representation of a field containing a finite number of elements. The finite field of a certain order q (where q equals the number of elements) exists only when q=p^{k}, where p is a prime number and k is a positive integer. For polynomial factorization, there are efficient algorithms developed for factoring the polynomials over finite field. In particular, to study solvability by radicals of a polynomial equation f(X)=0, we let K be the field generated by the coefficients of f(X), and let F be a splitting field for f(X) over K.

While Galois considered permutations of the roots that leave the coefficient field fixed, a modern approach is to consider the automorphisms determined by these permutations. It is noted that any automorphism of a field F must leave its prime sub field fixed.

Proposition.

Let F be an extension field of K. The set of all automorphisms ϕ: F→F such that ϕ(a)=a for all a in K is a group under composition of functions.

### Definition

Let F be an extension field of K. The set {θ∈Aut(F)|θ(a)=a ∇a∈K} is called the Galois group of F over K, denoted by GF(F/K).

### Definition

Let K be a field, let f(X)∈K[X], and let F be a splitting field for f(X) over K. Then GF(F/K) is called the Galois group of f(X) over K, or the Galois group of the equation f(X)=0 over K.

Proposition.

Let F be an extension field of K, and let f(X)∈K[X]. Then any element of GF(F/K) defines a permutation of the roots of f(X) that lie in F.

Lemma.

Let f(X)∈K[X] be a polynomial with no repeated roots and let F be a splitting field for f(X) over K. If ϕ:K→L is a field isomorphism that maps f(X) to G(X)∈L[X] and E is a splitting field for g(X) over L, then there exist exactly [F:K] isomorphisms θ:F→E such that ϕ(a)=θ(a) for all a in K.

Theorem.

Let K be a field, let f(X)∈K[X], and let F be a splitting field for f(X) over K. If f(X) has no repeated roots, then [GF(F/K)]=[F:K].

Corollary.

Let K be a finite field and let F be an extension of K with [F:K]=Δ. Then GF(F/K)=Δ is a cyclic group of order Δ.

Now assuming that there is a finite field and its elements are generated by the polynomial g(X)=X⁴+X³+1, then the elements are given in Table 1 below.

TABLE 1
the finite field elements where the prime numbers are in bold

| Power | Inverse | Polynomial | n-Tuple | Hexadecimal | Decimal |
|---|---|---|---|---|---|
| Form | Form | Form | Form | Form | Form |
| 0 | — | 0 | 0000 | 0 | 0 |
| 1 | α⁻¹⁵ | 1 | 0001 | 1 | 1 |
| α | α⁻¹⁴ | α | 0010 | 2 | 2 |
| α² | α⁻¹³ | α² | 0100 | 4 | 4 |
| α³ | α⁻¹² | α³ | 1000 | 8 | 8 |
| α⁴ | α⁻¹¹ | α³ + 1 | 1001 | 9 | 9 |
| α⁵ | α⁻¹⁰ | α³ + α + 1 | 1011 | B | 11 |
| α⁶ | α⁻⁹ | α³ + α² + α + 1 | 1111 | F | 15 |
| α⁷ | α⁻⁸ | α² + α + 1 | 0111 | 7 | 7 |
| α⁸ | α⁻⁷ | α³ + α² + α | 1110 | E | 14 |
| α⁹ | α⁻⁶ | α² + 1 | 0101 | 5 | 5 |
| α¹⁰ | α⁻⁵ | α³ + α | 1010 | A | 10 |
| α¹¹ | α⁻⁴ | α³ + α² + 1 | 1101 | D | 13 |
| α¹² | α⁻³ | α + 1 | 0011 | 3 | 3 |
| α¹³ | α⁻² | α² + α | 0110 | 6 | 6 |
| α¹⁴ | α⁻¹ | α³ + α² | 1100 | C | 12 |

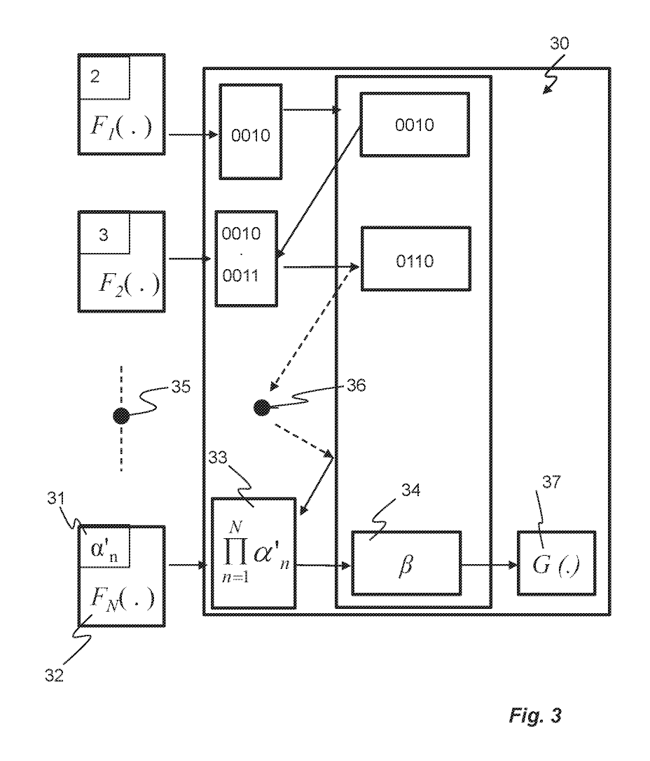

A blocksheet representation 30 of the method, and the controller programmed to execute the method, according to an embodiment is presented in FIG. 3.

Assume that there are N processing components, units of functions here called Fₙ where n∈[1, N] which are connected to each other in series, parallel or a combination of series and parallel. Each of the these contain a unique prime number {α}ₙ₋₁^{N}={2, 3, 5, 7, . . . } coded as a unique finite field element from the generated field {α}′ₙ₌₁^{N}={0010, 0011, 0101, 0111, . . . } that acts as an ID for the actual Fₙ. Each unique label in the form of a finite field element is thus corresponding to a unique decimal form representation, i.e. a unique prime number. The number 1 is not used in the set of unique prime numbers, but the number 1 is used as error set value. In each step the prime numbers α′ₙ is multiplied by the product of prime numbers βₙ₋₁ from the previous steps, α′ₙβₙ₋₁ to produce βₙ.

βₙ=α′ₙβₙ₋₁

These products are stored in a memory and virtually propagated to the next Fₙ. When all Fₙ are executed and the final product is calculated then the final product is compared to an expected values.

Hence, the proposed method 30 comprises the following sub-functions, which also represent operating modules of the controller configured to perform the method:

In 31, a unique prime number label, α′ₙ in form of a finite field element, that act as ID for the actual function or unit Fₙ and is used as a factor to produce the product by multiplication.

In 32, the function or unit that would be monitored is connected to the next function or unit in serial, parallel or in a combination of serial and parallel. The default output values from these function or unit is the finite field element 0001.

In 33, it is provided a multiplier function or unit that multiplies the product βₙ₋₁ from the previous steps by the actual prime number, α′ₙ in form of a finite field element to form a new product βₙ.

Reference numeral 34 represents a “hole less” memory unit or some other storage.

Reference numeral 35 represents the data path between the function or units F_{N}.

Reference numeral 36 represents the product propagation to next functions or units from the data storage corresponding to the previous step.

Reference numeral 37 represents a fault comparator and unique factorisation unit being configured to determine if any functional units are faulty and if so, which units are faulty.

As mentioned above the functional units may be connected in series. The functional units may also be connected in parallel. The functional units may also be connected in a combination of series and parallel.

In an embodiment the functional units may be a subgroup selected from the functional units comprised in the vehicle control system. In such an embodiment the functional unit subgroup may be associated with a specific function of the vehicle. The functional unit subgroup may in an embodiment be associated with multiple related functions of the vehicle. The expected traversal value of the functional unit subgroup is the product of the unique label of each of the functional units comprised in the functional unit subgroup.

One unique factorisation algorithm is described hereafter. If the final product, β_{N}, of unique labels in the form of finite field element is equal to the expected value then there is no faults.

If the final product β_{N} of unique labels in the form of finite field element is unequal to the expected value then there is one or more faults.

The following procedure is used to figure out where the faults occur:

In a first step, to figure out where the faults have occurred the final product is divided by the first and least common finite field element α′₁=0010.

In a second step, if the quotine is unequal to a finite field element in the given set then the procedure is continued by a yet further division by the next finite field element. In another case, if the quotine is a finite field element in the given set then the iteration is interrupted. The procedure for detecting faults by factorization can be described by the following algorithm:

$${α}_{1}^{′} = 0010.$$

$$\frac{{β}_{N}}{{α}_{1}^{′}} \to {γ}_{1}$$

$$For n = 1 to N$$

$$\frac{{γ}_{n - 1}}{{α}_{n}^{′}} \to {γ}_{n}$$

$$End$$

Once the procedure above is performed, fault detection is continued by performing a comparison by checking the difference between the complete used set of finite field elements and the set of obtained finite field elements during the iteration. The result of the comparison, i.e. the missing elements, represent the ID(s) for the faulty functions or units.

As explained above the vehicle control system may also comprise subsystems being associated with vehicle hardware. In such a case the subsystems comprise the functional units. For example, a drivetrain subsystem could comprise multiple functional units associated with of the combined pieces of hardware associated with the vehicle's drivetrain.

If the functional units are comprised in subsystems then the method of detecting faults may further comprise associating the functional units with the comprising subsystem.

The method of detecting faults in a vehicle control system may also comprise a step for determining which hardware component is associated with a functional unit. The method can comprise accessing a list associating a hardware descriptor to a functional unit. The list may comprise a sequence of unique labels as described above, being the unique labels of the function units. The list may also comprise a text-based or other descriptor of which vehicular hardware component is related to each unique label. The descriptor could be any machine or human readable descriptor or ID of a vehicular hardware component.

Also disclosed herein is a controller for detecting faults in a vehicle control system, wherein the system comprises functional units. For identification each of the functional units of the vehicle control system can be assigned a unique label in the form of a finite field element in accordance with the description above.

The controller for detecting faults thus also comprises a means of calling the functional units wherein the call to the functional unit comprises, a readable and updateable traversal value for enabling identification of which functional units are faulty.

The controller comprises a means of, in case the functional unit is operating correctly, updating the traversal value based on the unique label of the currently called functional unit, and in the case of a fault, not updating the traversal value.

The controller further detects whether the functional units are faulty as it is provided with means of comparing the traversal value with an expected traversal value, and a means of determining which functional units are faulty. In case the traversal value is equal to the expected traversal value then no faults have been detected in the vehicle control system. In the case that the traversal value is not equal to the expected traversal value the controller determines that one or more faults are present in the vehicle control system. The controller can determine which functional units are faulty by the unique factorisation algorithm.

A vehicle may comprise a system comprising at least one hardware component of a vehicle associated with one or more functional units and a controller according to the description above. For example a system could comprise a hardware component such as a brake actuation sensor, a controller as described above, and at least one functional unit. The system may further comprise a list associating a hardware component descriptor to a functional unit.

A processing unit is responsible for the overall operation and control of the method. The processing unit may be implemented in any known controller technology, including but not limited to a processor (PLC, CPU, DSP), FPGA, ASIC or any other suitable digital and/or analogue circuitry capable of performing the intended functionality. The processing unit constitutes an implementation of the method described herein.

Finally, the system and controller may have a memory which is operatively connected to the processing unit. The memory may be implemented by any known memory technology, including but not limited to E(E)PROM, S(D)RAM and flash memory, and it may also include secondary storage such as a magnetic or optical disc. Physically, the memory may consist of one unit or a plurality of units which together constitute the memory on a logical level. In addition to storing various program instructions and data for the various functions and applications which are typically available, the memory also comprises program instructions and work data for a control software application executed in the controller, system or processing unit.

Although the present invention has been described above with reference to specific embodiments, it is not intended to be limited to the specific form set forth herein. Rather, the invention is limited only by the accompanying claims.

1. A method for detecting faults in a vehicle control system comprising functional units, each functional unit having an associated unique label in the form of a finite field element, the method comprising:
calling each of the functional units, the call comprising a readable traversal value, and in case the functional unit is operating correctly, updating the traversal value based on the unique label of the currently called functional unit; and
determining from the updated traversal value if any functional units are faulty by a comparison with an expected traversal value.

2. The method according to claim 1, further comprising, in the case that the traversal value is not equal to the expected value, determining which functional units are faulty by a finite field element factorization algorithm.

3. The method according to claim 2, further comprising determining any missing unique label(s) by means of said finite field element factorization algorithm.

4. The method according to claim 1, further comprising accessing a list, the list associating a descriptor of a functional unit to a unique label, to determine the descriptor of any faulty functional unit(s).

5. The method according to claim 1, wherein the traversal value is the product of the traversal value in the call and the unique label of the currently called functional unit.

6. The method according to claim 1, wherein each unique element is generated by a polynomial.

7. The method according to claim 6, wherein the polynomial is g(X)=X⁴+X³+1.

8. The method according to claim 1, wherein each unique label corresponds to a unique decimal form representation, each unique decimal form representation is a prime number.

9. The method according to claim 8, wherein the unique decimal form representations are associated according to the ascending sequence of prime numbers starting at the number 2.

10. The method according to claim 8, wherein a unique prime number is excluded from the set of prime numbers forming the unique decimal form representations.

11. The method according to claim 1, wherein the vehicle control system comprises two or more functional units.

12. The method according to claim 1, wherein the vehicle control system further comprises subsystems being associated with vehicle hardware, wherein the subsystems comprise the functional units, the method further comprising associating the functional units with the comprising subsystem.

13. The method according to claim 1, wherein a functional unit subset is selected from the functional units comprised in the vehicle control system, and wherein the expected traversal value of the functional unit subset is the product of the unique label of each of the functional units comprised in the functional unit subset.

14. A method for providing at least one functional unit, wherein the method comprises assigning a unique label in the form of a finite field element to a functional unit.

15. A controller for detecting faults in a vehicle control system comprising functional units, wherein each of the functional units of the vehicle control system are assigned a unique label in the form of a finite field element, the controller for detecting faults comprising:
a means of calling the functional units wherein the call to the functional unit comprises a readable traversal value,
a means of, in case the functional unit is operating correctly, updating the traversal value based on the unique label of the currently called functional unit, and
a processing unit programmed to determine which if any of the functional units are faulty by a comparison between the updated traversal value and an expected traversal value.

16. The controller according to claim 15, wherein, if the updated traversal value is not equal to the expected traversal value, the processing unit is further programmed to determine which functional units are faulty by a finite field element factorization algorithm.

17. A system comprising a hardware component of a vehicle being associated with one of more functional units and a controller according to claim 15.
